(19) United States
(12) Patent Application Publication
(10) Pub. No.: US 2017/0114756 A1
(43) Pub. Date: Apr. 27, 2017

(54) CARBON COLLECTION AND UNTHROTTLED ENGINE OPERATION

(71) Applicant: McAlister Technologies, LLC, Phoenix, AZ (US)

(72) Inventor: Roy Edward McAlister, Phoenix, AZ (US)

(21) Appl. No.: 15/314,917

(22) PCT Filed: May 29, 2015
(86) PCT No.: PCT/US2015/033347

§ 371 Date: Nov. 29, 2016

Related U.S. Application Data
(60) Provisional application No. 62/004,803, filed on May 29, 2014.

(51) Int. Cl. F02M 25/12; F02M 27/04; F02D 41/00; F02B 43/10; F02D 19/06

(52) U.S. Cl. CPC F02M 25/12; F02B 43/10; F02D 19/0671; F02D 41/0027; F02M 27/04; F02B 2043/103

(57) ABSTRACT

The present application provides systems and methods for chemically combusting a feedstock in the presence of an oxidant.

### TECHNICAL FIELD

The present disclosure relates to systems and methods for chemically combusting a feedstock in the presence of an oxidant.

### BACKGROUND

Plentiful supplies of relatively inexpensive natural gas have been developed in North America largely because of shale fracturing or “fracking” and improved secondary and tertiary production from partially depleted geological formations. Similar production technology improvements are expected to improve natural gas availability throughout the world.

The present stage of the Industrial Revolution depends upon burning more than a million years' of fossil coal, oil and natural gas each year. More plentiful supplies of inexpensive natural gas may potentially reduce objectionable emissions of heavy metals and particulates from coal combustion but may accelerate economic development and the rate that fossil carbon enters the atmosphere to cause more greenhouse gas related weather extremes and damages to the built and natural environments.

Difficult problems concerning lower energy density, gaseous fuel metering fidelity, requirements for ionizing ignition, and reduced combustion rates are encountered in efforts to utilize less expensive natural gas in place of gasoline and diesel fuels. Spark ignition of fossil natural gas or renewable methane in combustion engines requires production of a fuel-air ratio within narrow limits. Fuel must be proportioned in accordance with a variable amount of inlet air which is provided by restrictive “throttling” of the air throughout the range of operating conditions including idle, acceleration, deceleration, cruise, and higher power production.

Illustratively, a mixture of methane and air will combust only if the fuel concentration lies within a relatively narrow range between lower and upper bounds that are referred to as flammability or explosive limits. The combustible methane-air mixture must be between about 5 and 16% methane by volume in the combustion chamber particularly including the small amount of the mixture in the spark plug electrode gap to initiate the sub-sonic rate of combustion propagation that follows. Moreover, in order to meet fuel economy and exhaust emissions requirements the acceptable fuel-air ratio must be further narrowed to the lean fuel portion of the air-fuel ratio that can be combusted to assure that excess oxygen is in the gases that are exhausted.

Operation within such narrow combustibility limits throughout the useful range of power production operations including transient conditions between idle, cruise, and full power operation requires inlet air throttling for more than 95% of the engine life to assure production of flammable homogeneous methane-air mixtures. This is unfavorable because such throttling of inlet air reduces the volumetric and thermal efficiencies of engine operation along with compromised power production and engine life, In many engines further volumetric and thermal efficiency compromises result from conventional mixing of the fuel and air in the inlet system of the engine to achieve sufficiently homogenous fuel-air mixtures for sparkplug initiated combustion.

Hydrogen-air mixtures provide a much wider flammability range of about 4 to 75% hydrogen by volume. This wide flammability range of hydrogen-air mixtures enables engine operation without throttling of inlet air. Excellent control of engine operations is provided by combusting un-throttled inlet air with metered amounts of directly injected hydrogen to meet energy conversion requirements for idle, acceleration, cruise, and full power production.

Such unthrottled air and stratified charge hydrogen combustion provides considerably higher volumetric and thermal efficiency in comparison with combustion of mixtures of throttled air and methane. Important related benefits provided by hydrogen include considerably reduced ignition energy requirements and operation at overall equivalence ratios that are much leaner than the stoichiometric value along with five- to fifteen-times faster and far cleaner burning characteristics along with carbon-free emissions (i.e. absence of carbon monoxide, carbon dioxide, or hydrocarbon substances including many carcinogens.)

### SUMMARY

The present disclosure provides systems and methods for chemically combusting a feedstock in the presence of an oxidant.

In one embodiment, a system for chemically combusting a feedstock is provided. In some embodiments, the system requires a first ratio of feedstock to oxidant proportions for ignition and self-propagated combustion. In some embodiments, the first ratio requires attenuation of the oxidant availability as the feedstock is attenuated to provide ignition and self-propagated combustion. In some embodiments, the system separates the feedstock into at least a first chemical constituent and a second chemical constituent. In some embodiments, the first or second constituent is selected to provide a ratio of selected constituent to oxidant proportions that sufficiently exceeds the first ratio of feedstock to oxidant proportions to provide for ignition and self-propagated combustion of the selected constituent without requiring attenuation of the oxidant.

In another embodiment, a method of chemically combusting a feedstock is provided, the method comprising providing a feedstock and an oxidant in a first ratio suitable for enabling ignition and self-propagated combustion. In some embodiments, the method further comprises attenuating availability of the oxidant upon attenuation of the feedstock availability. In some embodiments, the method further comprises separating the feedstock into a first chemical constituent and a second chemical constituent, for example to provide a ratio of the first or second chemical constituent to the oxidant that is greater than the first ratio of feedstock to oxidant, wherein the ratio of the first or second chemical constituent is selected so as to not require attenuation of the oxidant availability to enable ignition and/or self-propagated combustion.

### BRIEF DESCRIPTION OF THE DRAWINGS

FIG. 1A schematically illustrates principles of the invention.

FIG. 1B schematically illustrates additional features according to the principles of operation.

FIG. 1C schematically illustrates additional features according to the principles of operation.

FIG. 2A schematically illustrates additional features according to the principles of operation.

FIG. 2B schematically illustrates additional features according to the principles of operation.

FIG. 2C schematically illustrates additional features according to the principles of operation.

FIG. 2D schematically illustrates additional features according to the principles of operation.

FIG. 3A schematically illustrates additional features according to the principles of operation.

FIG. 3B schematically illustrates additional features according to the principles of operation.

FIG. 3C schematically illustrates additional features according to the principles of operation.

FIG. 3D schematically illustrates additional features according to the principles of operation.

FIG. 3E schematically illustrates additional features according to the principles of operation.

FIG. 3F schematically illustrates additional features according to the principles of operation.

FIG. 3G schematically illustrates additional features according to the principles of operation.

FIG. 4A schematically illustrates additional features according to the principles of operation.

FIG. 4B schematically illustrates additional features according to the principles of operation.

FIG. 4C schematically illustrates additional features according to the principles of operation.

FIG. 5A schematically illustrates additional features according to the principles of operation.

FIG. 5B schematically illustrates additional features according to the principles of operation.

FIG. 5C schematically illustrates additional features according to the principles of operation.

FIG. 5D schematically illustrates additional features according to the principles of operation.

FIG. 6 schematically illustrates additional features according to the principles of operation.

FIG. 7 schematically illustrates additional features according to the principles of operation.

### DETAILED DESCRIPTION

Hydrogen can produce many other favorable engine operations including suitable blends with fuels such as hydrocarbons (i.e. methane, ethane or propane) or fuel alcohols (i.e. methanol, ethanol, butanol, etc.) to enable unthrottled engine operation. Such hydrogen additions widen the flammability limits and reduce spark ignition energy to more rapidly complete the combustion of various hydrogen-fuel mixtures with air. This enables ignition near, at, or after top dead center (TDC) depending upon piston speed and combustion chamber characteristics to substantially improve the volumetric and thermal efficiencies of the engine.

Improved thermal efficiency and engine performance benefits are provided by conversion of engines designed for gasoline or diesel fuel to operation with unthrottled air intake and various regimes of hydrogen-enhanced stratified charge combustion. Various regimes of such hydrogen-enhanced combustion include operational modes such as:
1) Production of one or more sparks proximate to the hydrogen-fuel blend that is directly injected into the combustion chamber during the period of time that the injected blend is expanding into and mixing with oxidant such as air. This advantage incorporates the higher rare of hydrogen departure from the injection plume and consequent formation of suitable combustible mixtures with the oxidant such as air. Thus the hydrogen-rich mixture zones expanding from the surface of the injected pattern to rapidly ignite and expedite the subsequent combustion of the remaining fuel inventory that is presented within the combustion chamber. This includes the inventory of fuel that may be in stratified and/or homogeneous mixtures.
2) Stratified distribution of Lorentz thrust ions and/or radicals derived from oxidant such as air that precedes the direct injection of fuel into stratified activated oxidants such as O⁻O₃, NOₓ, OH⁻ etc. Lorentz on thrust is produced by creating a current between two electrodes in which the current is thrust toward the combustion chamber by the combined electro-magnetic field effects that are interactively produced.
3) Stratified distribution of Lorentz thrust ions and/or radicals derived from oxidant such as air in which such activated states may include O ions, nacent O, Ozone, NOₓ, OH⁻ etc., to initiate combustion of fuel such as blended hydrogen-fuel that mixes with oxidant.
4) Production of ions from the hydrogen-fuel blend that are Lorentz thrust into the combustion chamber to initiate combustion upon penetration into oxidant such as air within the combustion chamber.
5) Production of Corona ignition of the stratified mixture of the hydrogen-fuel blend and oxidant such as air in the combustion chamber. Corona ignition occurs in instances that an ionizing electric field is applied to an electrode or antenna at a sufficiently high frequency or in a sufficiently short time interval (i.e. nanoseconds) to preclude formation of an arc current of heated ions and thus the electrical energy can be expended to produce relatively cold corona plasma within the combustion chamber.
6) Production of Corona ignition of the stratified mixture of oxidant such as air and the hydrogen-fuel blend in a pattern that includes ions previously derived from fuel and or oxidant such as air. Injection of a pattern of Lorentz thrust oxidant and/or fuel ions into the combustion chamber efficiently shapes the subsequent Corona plasma to accelerate the ignition and completion of combustion of fuel in the combustion chamber.
7) Production of Microwave and/or UV ignition and/or acceleration of combustion of the stratified mixture of the hydrogen-fuel blend and oxidant such as air in the combustion chamber.
8) Production of Microwave and/or UV ignition and/or acceleration of combustion of the stratified mixture of oxidant such as air and the hydrogen-fuel blend in a pattern that includes ions previously derived from fuel and or oxidant such as air,
9) Initial preparation of a homogeneous fuel mixture of unthrottled oxidant with fuel that is ignited by an adaptively adjusted stratified pattern of hydrogen or hydrogen-characterized fuel that penetrates the homogeneous charge. This includes homogeneous charge mixtures that are very lean and initial ignition of the hydrogen or hydrogen-characterized fuel by spark, Lorentz thrust ions, and/or corona ignition.

In operation a chemical combustion system of selected embodiments is provided for feedstocks that require a first range of feedstock to oxidant proportions for ignition and self-propagated combustion in which the first range requires attenuation of the oxidant availability as the feedstock is attenuated to provide ignition and self-propagated combustion. The system provides separation of the feedstock into at least a first chemical constituent and a second chemical constituent whereby the first or the second constituent is selected to provide a range of selected constituent to oxidant proportions that sufficiently exceeds the first range of feedstock to oxidant proportions to provide for ignition and self-propagated combustion of the selected constituent without requiring attenuation of the oxidant. This is particularly suitable for feedstocks that contain hydrogen. In instances that the feedstock also contains carbon (i.e. CₓH_{y}), it is advantageous to utilize the separated hydrogen for combustion with unthrottled oxidant such as air and to use the carbon for non-combustion purposes (i.e. production of durable goods). Ignition may be by suitable methods including hot spot (i.e. a glow-plug), and/or by pressure and/or electrically induced ionization and/or catalytic oxidation and/or by a selected spectrum of radiation induced oxidation. Combustion may be by homogeneous charge or stratified charge mixtures of the feedstock or the selected constituent with throttled (i.e. attenuated) or unthrottled (i.e. not attenuated) oxidant such as air. Combustion may include mixtures of feedstock and the selected constituent and/or mixtures of feedstock and the selected constituent and/or the other constituent.

In an embodiment activated oxidant ions and/or radicals are injected into the combustion chamber in a pattern that is intercepted by fuel such as a selected feedstock or a derivative or constituent of the feedstock and/or ions or radicals of the feedstock or derivative or constituent. Such interception may be a result of fuel velocity and/or mobility that exceeds the velocity of particles in the activated oxidant as a result of pressurized entry into the combustion chamber and/or acceleration due to electrical impetus such as ionization or heating or combustion or partial combustion of the fuel that enters the combustion chamber.

In another embodiment a relatively slow entry pattern of such fuel into the combustion chamber precedes a faster entry of fuel and/or ions or radicals that initiate combustion and intercept the slow entry pattern. Such combustion may be supported by oxidant and/or activated oxidant including ions and/or radicals.

In certain applications the feedstock (e.g. ammonia, urea, methane, ethane, propane, butane, fuel alcohols or CₓH_{y} including polymers) contains hydrogen. Illustratively natural gas contains carbon and hydrogen and may be used as a feedstock that is combusted by injection into the pattern of activated oxidant or natural gas may be partially activated by electrical, thermal, radiant (i.e. X-ray, UV, microwave) energy to produce ions and/or radicals such as CH₃, CH₂, CH, and various activated forms of hydrogen i.e. H, H₃ etc., to induce ignition and combustion upon penetration into oxidant in the combustion chamber. In other applications the feedstock that contains hydrogen is dissociated or separated into hydrogen and other constituents such as nitrogen, carbon, carbon monoxide, carbon dioxide, etc., and the hydrogen or hydrogen characterized constituents are injected into the pattern of activated oxidant to induce accelerate ignition and/or completion of combustion.

In other embodiments such hydrogen or hydrogen characterized constituents are partially activated to produce ions and/or radicals that are injected as a pattern into oxidant in the combustion chamber to accelerate initiation and/or completion of combustion.

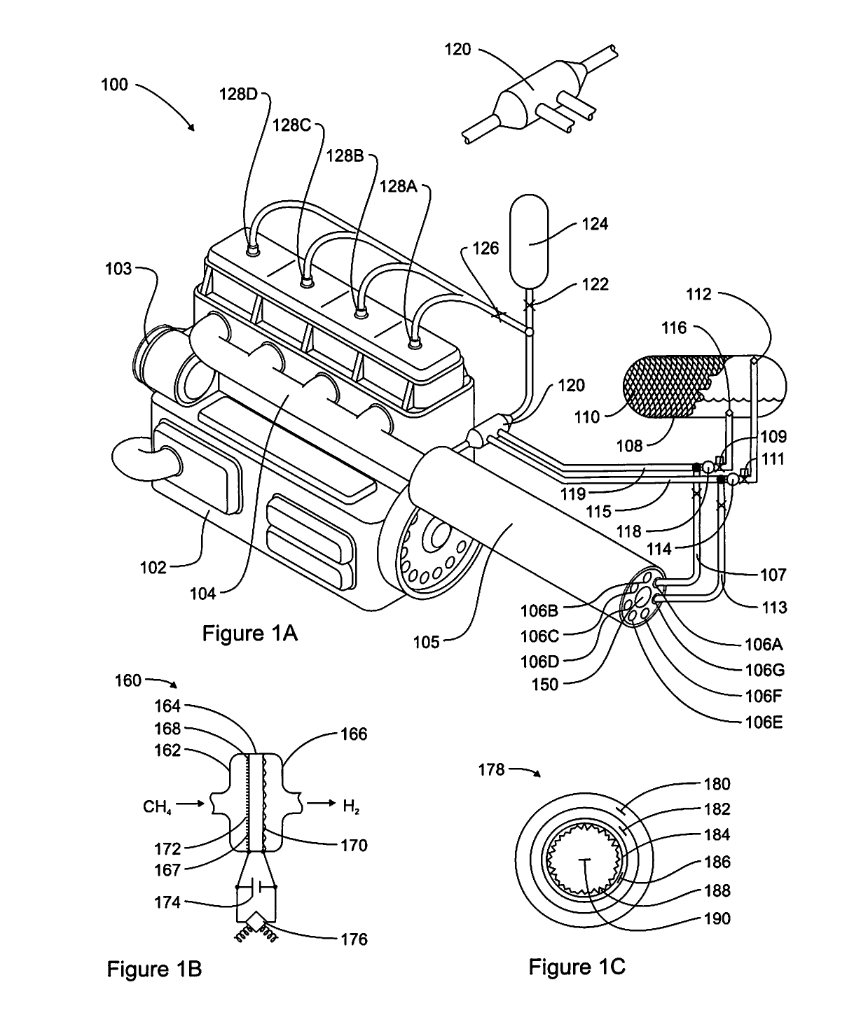

FIG. 1A shows a system 100 for utilizing energy provided by engine coolant (H-1), engine exhaust gases (H-2) that travel through exhaust manifold 104 and reactor 105 and/or regenerative energy (H-3) to separate and/or dissociate feedstock fuels that contain hydrogen and carbon such as CₓH_{y} to produce sufficient hydrogen to improve the flammability limits and other desirable combustion characteristics in mixtures with the feedstock. Hydrocarbons contain various proportions of carbon and hydrogen but other substances that rot or burn such as lingo-cellulosic materials are more complex as generalized by Equation 1B, Equations 1A and B delineate such dissociation to produce carbon and hydrogen.

CₓH_{y}+(H-1, H-2, and/or H-3)→xC+0.5yH₂ Equation 1A

CₓH_{y}O₂+(H-1, H-2, and/or H-3)→x-zC+0.5yH₂+x-zCO Equation 1B

Equations 2-10 show processes for production of hydrogen for such advantageous hydrogen-fuel blends from exemplary selections of methane, methanol, nitrogenous compounds such as ammonia and soluble or suspended substances exemplified by urea, cellulose, and other wastes.

CH₄+(H-1, H-2, and/or H-3)→C+2H₂ Equation 2

CH₃OH+(H-1, H-2, and/or H-3)→CO+2H₂ Equation 3

CH₃OH+H₂O+(H-1, H-2, and/or H-3)→CO₂+3H₂ Equation 4

2NH₃+(H-1, H-2, and/or H-3)→N₂+3H₂ Equation 5

CH₄N₂O+(H-1, H-2, and/or H-3)→N₂+CO+2H₂ Equation 6

2CH₄N₂O+H₂O+(H-1, H-2, and/or H-3)→2N₂+CO+CO₂+5H₂ Equation 7

C₆H₁₀O₅+H₂O+(H-1, H-2, and/or H-3)→6CO+6H₂ Equation 8

CH₃OH+0.5HCOOH+(H-1, H-2, and/or H-3)→CO₂+3H₂ Equation 9

CH₄+HCOOH+(H-1, H-2, and/or H-3)→2CO+3H₂ Equation 10

Particularly attractive economic advantages result from utilization of endothermic reactions to produce carbon along with hydrogen by processes such as shown in Equations 1 and 2. Produced carbon may be utilized to manufacture durable goods such as carbon reinforced and/or otherwise enhanced equipment that sustainably collect as much solar, wind, moving water, or geothermal energy numerous times each year compared to burning the carbon. Utilizing collected carbon to make durable goods thus eliminates 3.67 tons of atmospheric CO₂ production per ton of carbon that is made into products that can provide far greater ultimate energy production and economic development benefits.

This is an important embodiment feature for overcoming wasteful carbon burning practices that increasingly cause global warming damages. Numerous synergistic combinations are provided by separating carbon and hydrogen from substances that ordinarily burn or rot into the atmosphere, utilization of such carbon to produce durable goods and equipment to harness renewable energy, and utilization of the co-separated hydrogen to fuel heat engines. Synergistic benefits include the use of hydrogen in blends or combinations with other fuels to enable greater energy conversion efficiencies commensurate with unthrottled air intake combined with homogeneous or stratified charge combustion and/or accelerated combustion at or after TDC to further improve engine efficiency and performance along with providing cleaner emissions, reduced operating noise, and extended engine life.

In an embodiment the carbon produced by exemplary processes such as summarized by Equations 1 and 2 is deposited or added to substrate such as an absorptive liquid or fused salt collector or filter media in system 106A-G. Suitable filter media includes various types and forms of silica, zirconia, and carbon aerogels including nanotube and/or graphene composites, metals such as copper, nickel, iron and steel foams or wool, crumpled and/or spiraled foils; graphite flakes, granules, foams and fibers; activated carbon, nanotubes, nanowire forms, amorphous carbon, fiber glass, zeolite, pearlite and diatomaceous earth. Deposits of amorphous, graphitic or other more valuable types of carbon are provided.

An exemplary embodiment produces nanowire forms that are deposited on selected media at catalyst sites in one or more cartridges in deposit passageways such as 106A, 106B, 106C, 106D, 106E, 106F and/or 106G as disclosed in U.S. Patent application 2013/0209683 which is incorporated herein by reference. By selection of other catalysts and/or suitable operating conditions, graphite, graphene, nanotubes are produced and a system serving engine 102 with a suitable hydrogen-fuel blend for unthrottled operation may provide for a different selection or mixed production of carbon allotropes in each deposit passageway.

Carbon collection and production of nanoparticle modified graphene 3D and/or 2D structures is enabled by customization of operating characteristics and processes. Defects such as one or more missing carbon atoms and/or nanoparticles that may be incorporated in the graphene crystal that is formed include atoms and/or combinations of boron, phosphorous, iron, tin, zinc, copper, platinum, gold, silicon, etc., and maybe utilized to catalyze or in conjunction with selected catalysts to produce combinations of graphene with nanotubes of selected compositions. In other instances nanoparticles are deposited and/or enacted by other nanoparticles for utilization on the surface of one or more graphene layer(s) to strain, warp, and/or modify the stress distribution and/or spacing between successive graphene layers. In other instances nanoparticles comprise catalysts for chemical process reactions that are conducted between graphene layers and/or at the edges of one or more graphene layers.

The amount of area available on the targeted deposition substrate and/or the magnitude and quality of the endothermic energy supplied by suitable sources such as H-1, H-2, and/or H-3 controls the amount of valuable carbon such as graphite, graphene, nanotubes, and/or nanowires that are grown and deposited. Thus the co-produced hydrogen is supplied at a controllable rate for blending with selected feedstocks including hydrocarbons such as butane, propane, ethane, or methane in suitable proportions to operate engine 102 without throttling the inlet air.

At times that the concentration of hydrogen in the mixture with the feedstock is desirably increased to meet needs such as power production and/or emission reduction the endothermic energy quality and/or quantity may be increased by utilization of energy stored in a battery, flywheel, or other storage and/or primary generation sources. Illustratively an engine operating as a stationary power source may utilize energy from such storage devices and/or electricity from a generator driven by the engine, and/or various types of off peak grid energy and/or energy from conversion of solar, wind, moving water, or geothermal resources to produce and store hydrogen to meet such needs. In some embodiments the carbon products shown in Equations 1 and 2 is utilized to produce the equipment for converting solar, wind, moving water or geothermal energy into energy carriers such as hydrogen or electricity.

In certain embodiments an electrochemical process is utilized to separate carbon and hydrogen from a feed stock hydrogen and carbon donor such as natural gas or renewable methane. System 160 of FIG. 1B includes an electrochemical cell comprising chambers 162 and 166, which are separated by membrane assembly 164. Membrane assembly 164 may include electrically conductive components or electrodes such as layers and/or screens on both sides of the hydrogen or proton conduction substance. Membrane assembly 164 provides transport of hydrogen and may be a relatively low temperature proton exchange membrane such as a polymer material with PolyAryleneEtherSulfonic acid (PAES) or PolyPerFluoroSulfonic acid (PPFS) groups for conducting hydrogen ions. A more efficient thermoelectrochemical (TEC) process utilizes an elevated temperature membrane such as selected Perovskite-like hydrogen ion transmitting materials between suitable electrodes such as nickel, cobalt, platinum, molybdenum, titanium or other metal or conductive ceramic electrodes such as silicon carbide or molybdenum disilicide (MoSi₂) to enable beneficial preheat additions of H-1 and/or H-2 to the feed stock to reduce the voltage required from source 174 for feed stock dissociation and deposition of carbon on electrode 172 as hydrogen ions are transported across membrane 164 for production of diatomic hydrogen as shown.

In operation of system 160, fuel (e.g., “CH₄” in FIG. 1B) is dissociated at electrode 167 as electrons are removed from hydrogen and transported externally by force of the voltage applied by power source 174 to electrode 170 on the opposite side of proton conductive membrane 164. Carbon is deposited on electrode 168 which comprises electrode 167 and one or more suitably selected forms of carbon that are grown or developed according to process inducements and adjustments such as the temperature, pressure, epitaxy, acoustical impetus, sequential applications of process gases, and/or DC, pulsed, or RF electromagnetic fields that may be applied in any suitable sequence or combination.

Regenerative energy (H-3) such as electricity from vehicle deceleration or suspension system generators and/or from generator 103 can be utilized through conditioner 176 charge a battery or directly deliver the DC required voltage. The carbon deposition and hydrogen separation assembly comprises a hydrogen permeable electrode 168 against a hydrogen ion transport media such as graphene and/or various orientations of nanotubes, and/or a Perovskite-like membrane.

A functionally similar system 178 that is configured to be compactly located in one or more passageways 106A-G of a processor such as 105 is shown in FIG. 1C. Systems 160 and 178 are configured to collect carbon deposits that are occasionally removed or such systems may be replaced by an empty system assembly to provide further use of the removed system for other purposes such as utilization of electrode 167, 168 and 172 in a carbon fuel cell in which membrane 164 is replaced by an oxygen transport membrane such as doped zirconia. Such carbon fuel cells can efficiently provide silent generation of electricity along with high purity carbon dioxide for pharmaceutical, electronics, or food preparation purposes along with preparation of liquid fuels by processes such as summarized by exemplary Equations 11-15.

Operation of an electrical circuit similar to 174-176 in a corresponding TEC system is provided by a tubular assembly 178, in which fuel selections such as methane from a pipeline or tank 108 may be preheated by additions of H-1 and/or H-2 before it enters passageway 190 and is dissociated to deposit carbon on electrode 188 as hydrogen is ionized by suitable application of voltage across electrode 188 on the inside of proton membrane 186 and electrode 184 on the outside of proton membrane 186. Hydrogen ions are transported to electrode 184 and receive electrons to produce hydrogen atoms and diatomic hydrogen is released into annular accumulator space 182. Transported hydrogen formed in accumulator 182 may be pressurized according to the magnitude of the voltage applied across electrodes 188 and 184.

Embodiments comprising membrane assemblies such as 167-164-170 can be developed by depositing carbon as one or more layers of graphene on a suitable substrate such as metal wools, foams or thin foil nickel or another material that induces graphene deposition. Suitable graphene depositions are made in a vacuum or partial pressure argon chamber by dissociation at suitable temperature such as about 700 to 1100° C. of gaseous hydrocarbon feedstocks such as methane, ethane, or propane and/or by solid or semisolid dissociation of materials such as various grades and types of petrolatum jelly. Graphene layer depositions may be made from sequentially varied feedstock recipes that may include selected donors of dopants or functionalizers such as nitrogen, iron, copper, cobalt, nickel, manganese, silicon, etc. Illustratively such dopants or functionalizers may be added to the gaseous, semisolid or solid feedstocks by selected derivative constituent donors such as urea and/or carbonyls of iron, nickel, cobalt, copper, manganese etc.

Graphene functionalization purposes may include production of electronic or photoelectronic capabilities and/or lattice deformation to provide desired hydrogen permeability. Upon establishment of one or more layers of graphene another layer of a suitable hydrogen transport substance such as a selected Perovskite-like or spinel ceramic, carbide, boron nitride, or diamond-like carbon may be deposited. Subsequent deposit or mechanical sandwiching of an outer layer of opposing conductive electrode 170 material such as graphene or variously oriented electrically conductive nanocarbon wires.

A related embodiment provides carbon deposition on a selected host electrode film such as nickel, iron, cobalt at a sufficient temperature to produce lower melting regions of solid solutions, or intermetallics including eutectic or eutectoid compositions that serve as pathways for transport and removal of host electrode material in areas with high residual free energy, which in some alloys may include multiple grain boundary intersectional zones or enrichment collections of impurity atoms. Such carbon-metal substances may be transported by enhanced diffusion to produce pores and may be further developed into hydrogen passageways by chemical etching to produce suitable transmission of hydrogen through such electrode material to facilitate efficient electron removal and transport through the external circuit. Opposing electrode 184 can comprise a suitably applied conductive deposit of graphene, graphite, metal plating, or various forms of screens.

Similarly, assembly 188-186-184 can be produced by forming a relatively thin conductive tube such as an electroless or electroformed nickel, copper, iron, or cobalt tube that subsequently receives a coating or one or more layers of graphene on a selected surface such as the outside surface which may be provided with the same or similar functionalization and/or functionally equivalent electrode permeability and/or porosity development enablements.

Alternate hydrogen conduction membrane materials include Perovskite-like layer that is provided by suitable methods including combustion processes and sol gel deposits that are converted to the desired capabilities by thermo-chemical processing. Illustratively the sol gel method of making ceramic compositions as disclosed in EP 0338799 provides a suitable process. In certain embodiments opposing a conductive electrode 184 material such as graphene, variously oriented electrically conductive nano-carbon wires, or a plated or swage assembled metal tube such as nickel that is treated to produce the desired hydrogen permeability or porosity is utilized.

Pressure containing outer tube 180 contains hydrogen that may be pressurized to the desired density by control of the voltage applied across electrodes 188 and 184. Such hydrogen may be stored in an accumulator such as 124 to enable direct injection or preparation of mixtures with another fuels that enable unthrottled engine operation or in instances of hydrogen production in surplus of this purpose it may be stored in tank 108 which may be of any suitable size and capability specifications to fulfill performance requirements including chemical compatibility, pressure containment, temperature rating, impact loading, etc., for the intended application.

Another embodiment provides for one or more fuels to be stored in tank 108. Illustratively, some embodiments utilize tanks designed for storage of compressed natural gas (CNG) that are repurposed to store gases such as methane, hydrogen, carbon monoxide and/or liquids such as alcohols, ethers, and fuel acids along with reactants or fire suppressants or bio-safety additives such as water. Selected fuels are delivered through filter inlet 112 and a valve and/or pump 114 such as gaseous methane through a suitable valve to one or more selected carbon deposit cartridges such as 106A which may be of any suitable length and constant or variable cross-section geometry. Similarly or one or more liquids such as propane or alcohols are delivered through inlet filter 116 and a valve or pump 118 to a suitable valve to one or more selected carbon deposit cartridges such as 106B.

A typical 500 HP modern diesel engine requires a parasitic load of about 70 HP to drive a high pressure pump for pressurizing the diesel fuel from ambient pressure storage to about 2000 bar (−29,000 PSI). In a system embodiment for converting a diesel engine from diesel fuel to alternative fuels, a fuel tank designed according to suitable mechanical and chemical specifications such as may be typical to high pressure storage of natural gas is interrogated by a suitable method such as a conductive or fiber optic cable or by a wireless link to determine the anticipated engine use such as range and duty cycle requirements.

Accordingly, the engine controller and/or the fueling station provides one or more calculations of range, power production, and cost regarding filling formulas for re-fueling fueling tank 108 with proportioned inventories of selected liquids such as methanol, ethanol, butanol, formic add, water, etc., and condensable fluids such as ethane, propane, butane etc., and/or selected gases such as methane, ethane, carbon monoxide, hydrogen, etc. The gas selection(s) may be added after or before inputting the liquid inventories to provide a “full tank” with starting pressure (P-1) sufficient for direct injection of metered fuel at adaptively selected crank-angle intervals before, at, or after TDC to deliver a substantial portion of the vehicle range and duty cycle without requirements for parasitic on-board mechanical fuel pumping. Utilization of the pressurized gas to deliver fuel selections such as the liquid inventory and/or portions of the gas inventory reduces or eliminates the previous parasitic diesel fuel pumping load on the converted engine and favorably improves performance and fuel economy along with reducing maintenance costs.

Further and subsequent improvements are provided for operational modes that include H-1, H-2 and/or H-3 utilization in endothermic conversion of the liquid fuel to hydrogen and other gaseous constituents such as shown by Equations 1-10 to enable production of pressurized products at pressure P-2 as supplied from pump valve assembly 118-109 and/or 114-111 which may be the same or greater than P-1 to provide greater range and operating efficiency as a result of the relatively minimal energy required to add a small amount of pressure by pump 109 the pre-pressurized flow at P-1 from tank 108. In such operational modes the selected liquids may be utilized to produce pressurized hydrogen and other gases that can be mixed in a suitable mixer or accumulator with the gaseous fuel selection from tank 108 to enable unthrottled engine operation with homogeneous and/or stratified charge fuel combustion.

This provides improved volumetric and thermal efficiencies, and higher fuel economy along with higher engine performance including peak deliverable torque and power production capabilities. Most applications provide surplus magnitudes of H-1, H-2 and/or H-3 that can be utilized to provide further improvements by converting additional liquid fuel inventories from tank 108 into hydrogen and other constituents that are added to tank 108 to further extend range and operating efficiencies.

In other applications, tank 108 may be of any suitable design including repurposed natural gas, gasoline, and diesel fuel tanks for storage of fuels including selections such as methane, ammonia, fuel alcohols, urea and/or soluble cellulose in water and/or other solvents and/or various other engineered fuels. In the depiction shown, tank 108 can be a repurposed compressed natural gas tank that is revised with suitable fittings for loading and interchangeably utilizing one or more gaseous fuels and/or one or more liquid fuels.

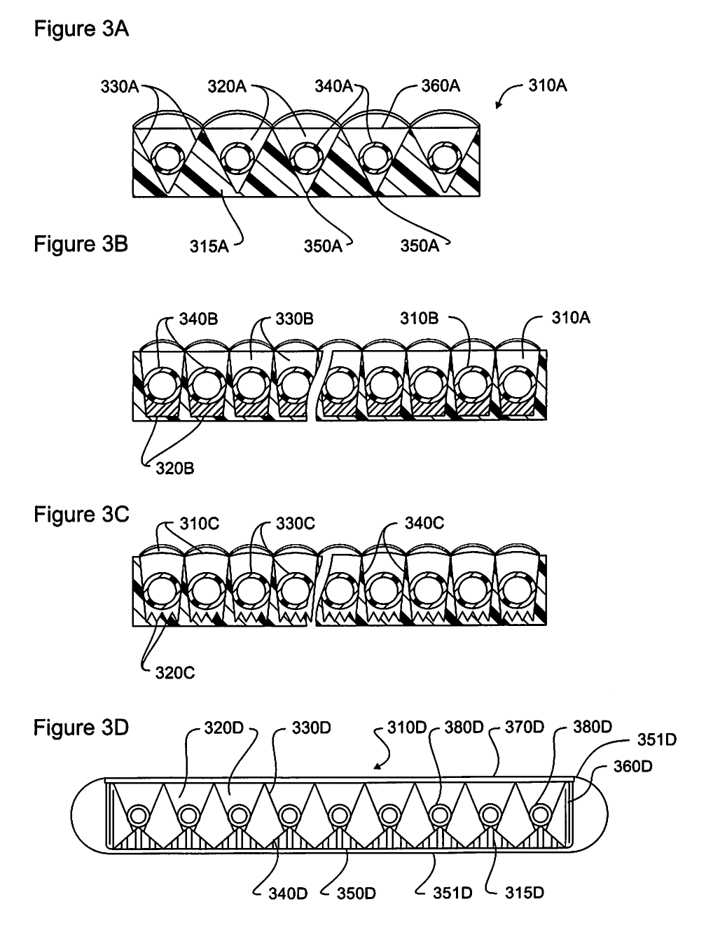

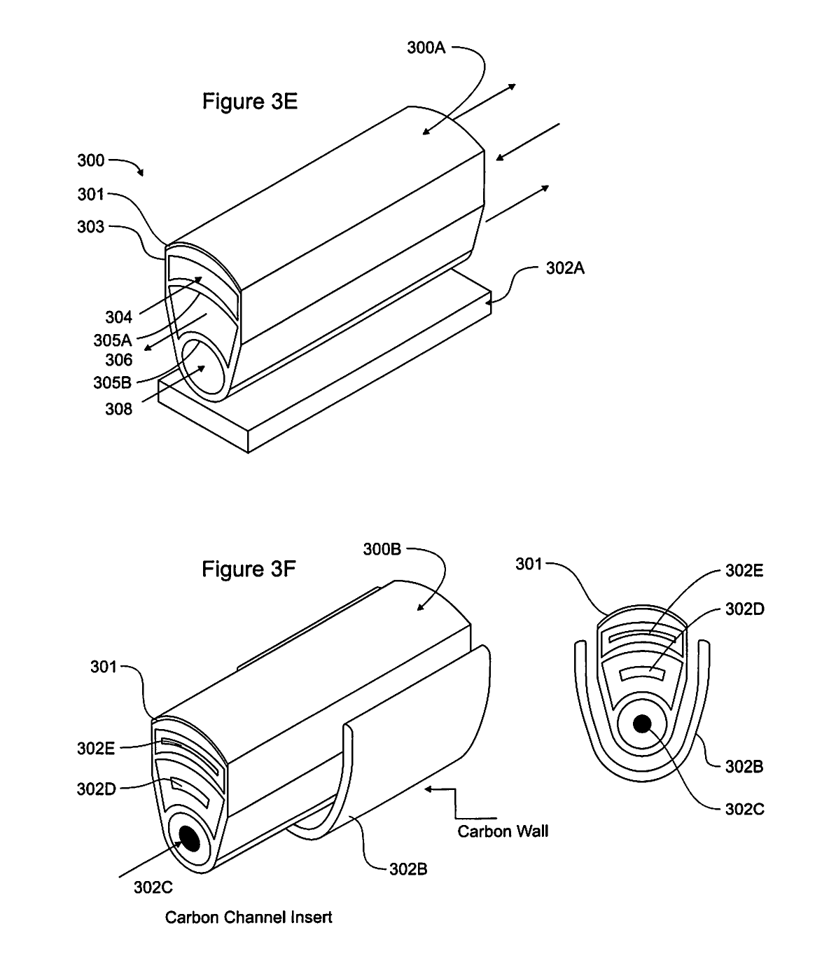

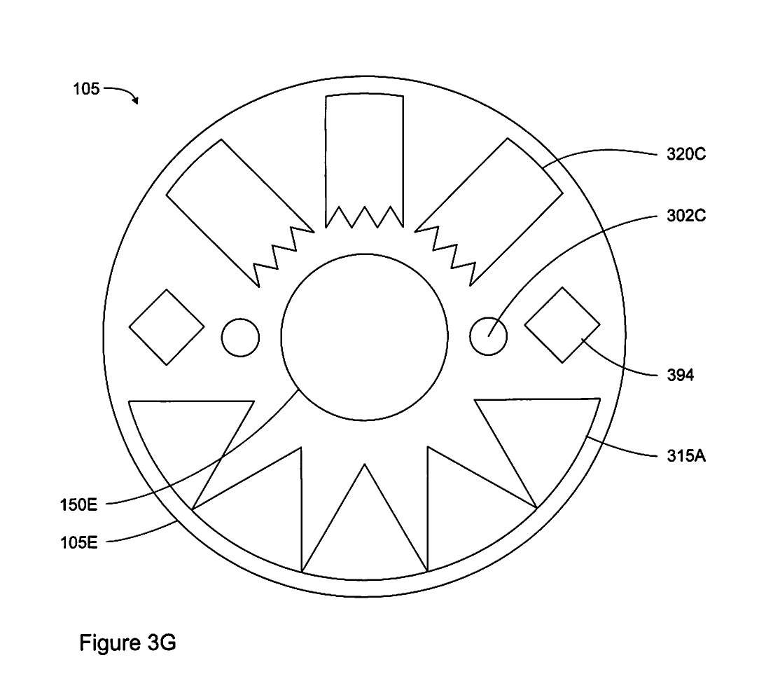

Carbon deposition and collection system 105 may be of any suitable configuration with one or more carbon removal subsystems such as cartridge filters with special shapes and cross sections may be located in the exhaust manifold or exhaust system before or after a turbo-charger or turbo-generator if present. In many applications the feed stock and/or the carbon receiving media is preheated by H-1, further heated by H-2 and if needed further heated by H-3. The section of carbon collector 105 that is schematically shown in FIG. 1A represents a portion for transfers of H-2 and/or H-3 after previous counter current heat exchange to provide transfer of H-1. Exhaust gases in one or more passageways such as 150 (FIG. 1A) or 150E (FIG. 3G) from engine 102 are passed around or in close proximity to carbon collector(s) 106A-G until the subsequent section for more thermally isolated H-3 additions to achieve a higher temperature or deposition rate.

Collection system 105 may be provided with interfaces and fittings to enable rapid removal and replacement with carbon deposition passageways of the size and shape needed for various products and purposes as shown in FIG. 3G. This enables rapid response to meet market demands with distributed production of components. Such local production to meet local demands greatly improves the manufacturing and supply system efficiencies along with reducing the environmental impact compared to conventional practices that often involve transcontinental and/or transoceanic shipment of feed stocks such as oil, cryogenic liquid natural gas, or L.P. gases to supply energy and carbon for production of durable goods that are then transported across continents and/or oceans to markets.

In some embodiments hydrogen is removed as it is produced by filtration such as a selective pore size media and/or a proton membrane such as a low temperature polymer or an elevated temperature carbon membrane including selections such as graphite, grapheme, and/or nanotubes; doped Perovskite and/or by such preparations as a galvanic separation membrane that applies an electric field to pressurize the separated hydrogen. Such separation of hydrogen as it is formed improves the rate and yield of hydrogen in reactions such as exemplary Equations 1 and 2.

In some embodiments carbon collection system 105 is suitably connected (i.e. by conduits 107 or 113) to provide feedstock fuel selections from tank 108 to one or more selections of deposit passageways 106 A-G. In certain applications the shape of the carbon deposition substrate and/or the shape of the filled substrate are appropriate for selected end uses.

In operation, carbon is deposited in the selected carbon deposit cartridges to provide hydrogen that mixes with the remaining source fuel to produce a fuel blend that does not require throttling the engine's inlet oxidant such as air. The resulting hydrogen-fuel blend is conveyed to mixer and heat exchanger 120, through valve 122 to accumulator 124 and/or through valve 126 to injectors such as 128A, 128B, 128C, 128D for applications such as direct injection into respective combustion chambers of engine 102. Surplus hydrogen or hydrogen-fuel inventory that can be produced in ordinary driving cycles with piston or turbine engines is stored in one or more accumulators (i.e. 124) and/or tank 108.

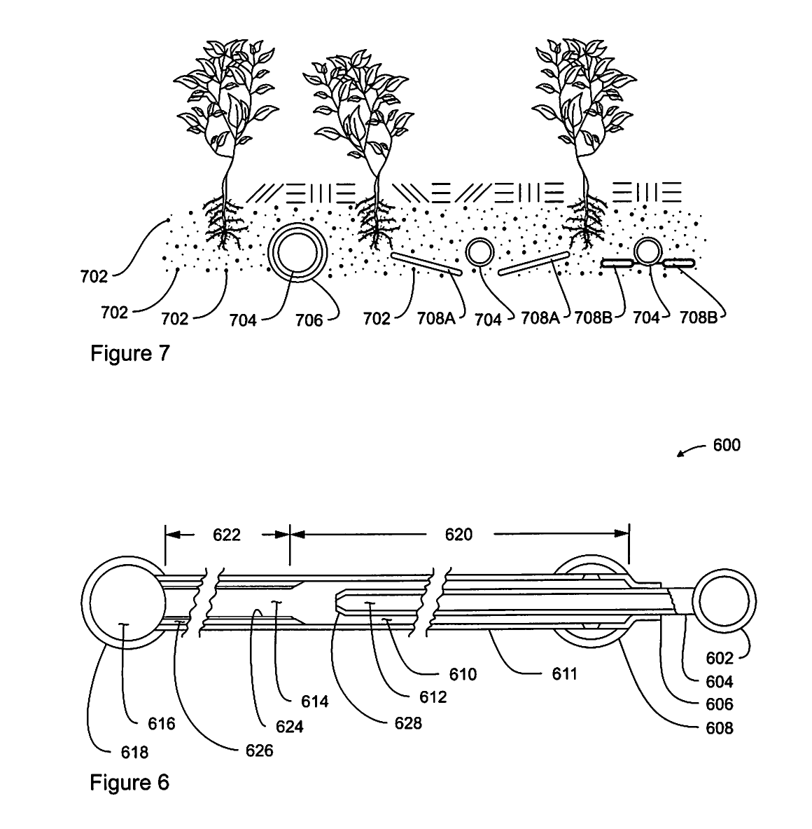

Applications that react oxygen donors such as formic aid or water as shown in Equations 4, 7, 8, and 9 it is advantageous to supply a substantial portion of the heat required for such endothermic reactions by preheating the oxygen donor to a sufficiently elevated temperature. System 600 of FIG. 6 illustrates such operations in which an oxygen donor such as water is supplied by manifold 608 to passageways 610 to provide heat such as H-1, H-2, and/or H-3 through walls 611 such as tube walls to preheat the oxygen donor such as steam to sufficiently elevated temperature for endothermic reaction with a reactant supplied through manifold 602. Supplying sufficient heat from the oxygen donor for the endothermic reaction to reduce or eliminate precipitation or deposition of fouling substances on the reactor walls or downstream surfaces improves heat transfer and extends the longevity of the system.

In the embodiment shown depending upon dimensions including distance 620, the flow rate and turbulence, and heat conduction properties of conduit 604 within walls 606, the reactant supplied through manifold 602 may be preheated to a controlled extent by heat transfer from the fluid in passageway 610. For substances that may precipitate unwanted fouling such as varnish or debris upon heating it is generally a design and control parameter to limit preheating of the reactant to a temperature that is below the threshold for production of fouling agents. Controlled pressure and rate of reactant delivery through passageway 612 may utilize a suitably configured nozzle 628 to mix with heated oxygen donor delivered through passageways such as 610 to produce sufficiently rapid production of hydrogen in passageway 614 without development of fouling agents. Such mixing may be gradual from radial slits, holes or slots and/or by various shapes of nozzle 628. Such mixing provisions may be configured for suitable acoustic frequency, kinetic acceleration, directional, fluidic or turbulent presentation of flow of fluid conveyed through passageway 612 into fluid conveyed through annular passageway 610.

Upon mixing with the preheated oxygen donor in flow zone 622 the reactant receives sufficient heat for rapidly reacting and producing products such as shown by Equations 4, 7, 8 and/or 9. In certain embodiments produced hydrogen is separated as it is formed by passage through filter or membrane 624 into coaxial passageway 626. Illustratively hydrogen may be removed as it is produced by filtration such as by a selective pore size media and/or a gas diffusion or proton membrane such as a low temperature polymer or an elevated temperature carbon membrane including selections such as graphite, graphene, and/or nanotubes; or by doped Perovskite and/or by such preparations as a galvanic separation membrane that selectively transports and pressurizes the hydrogen. Such separation of hydrogen as it is formed improves the rate and yield of hydrogen in reactions such as exemplary Equations 4, 7, 8 and/or 9.

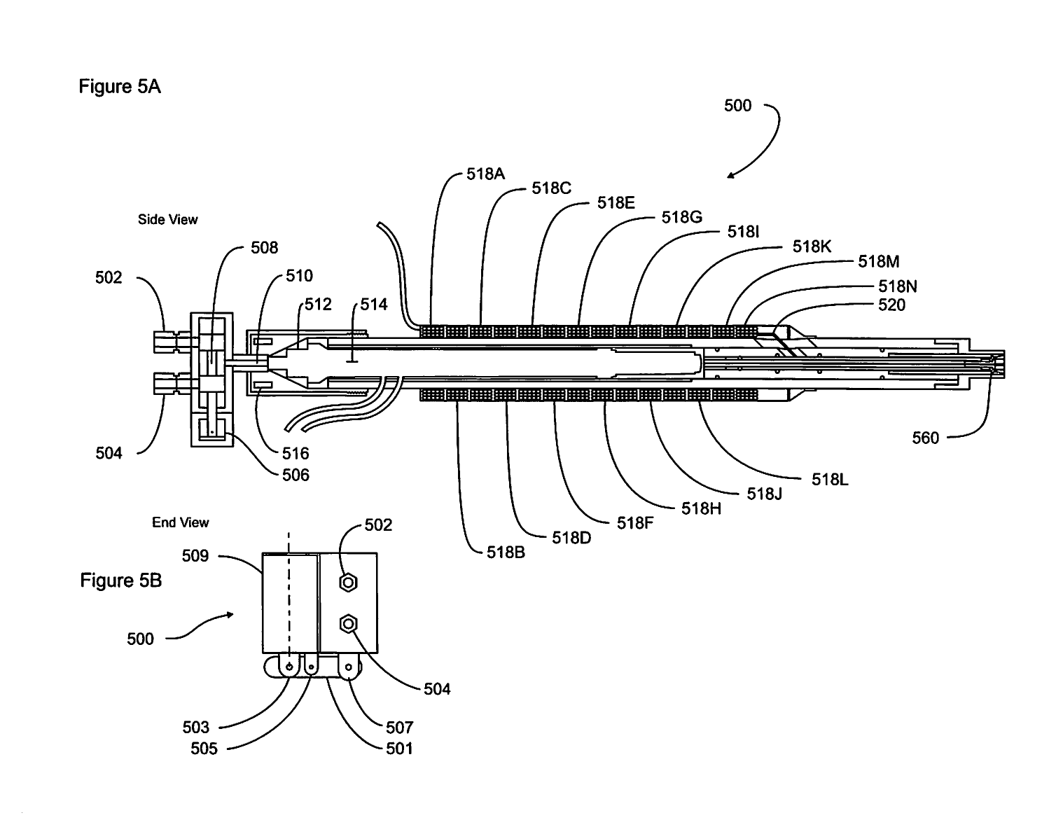

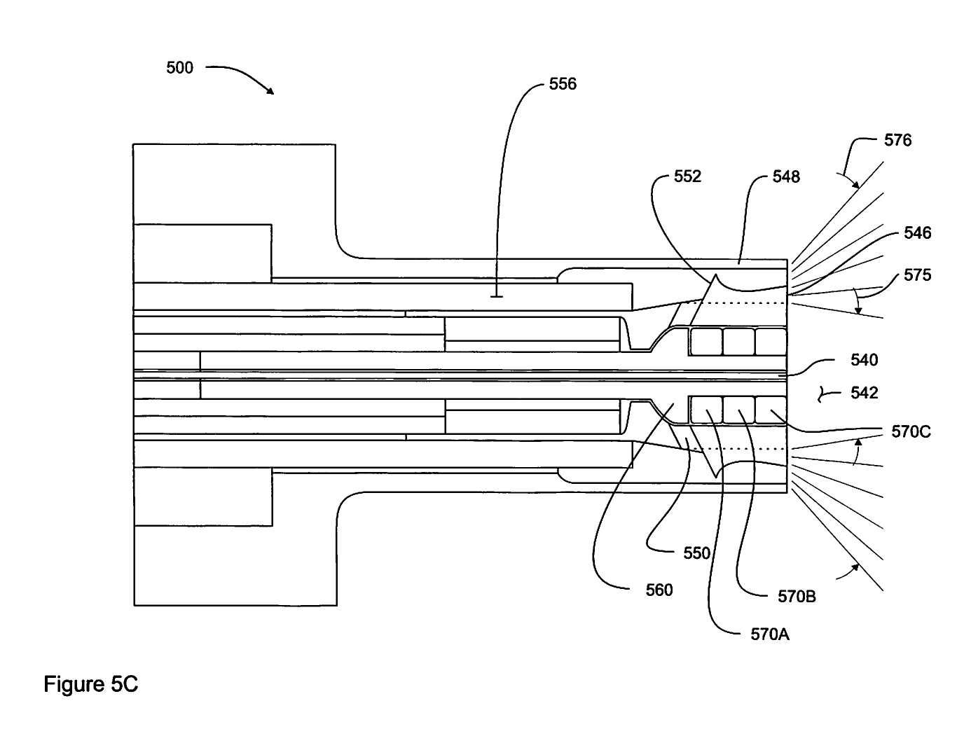

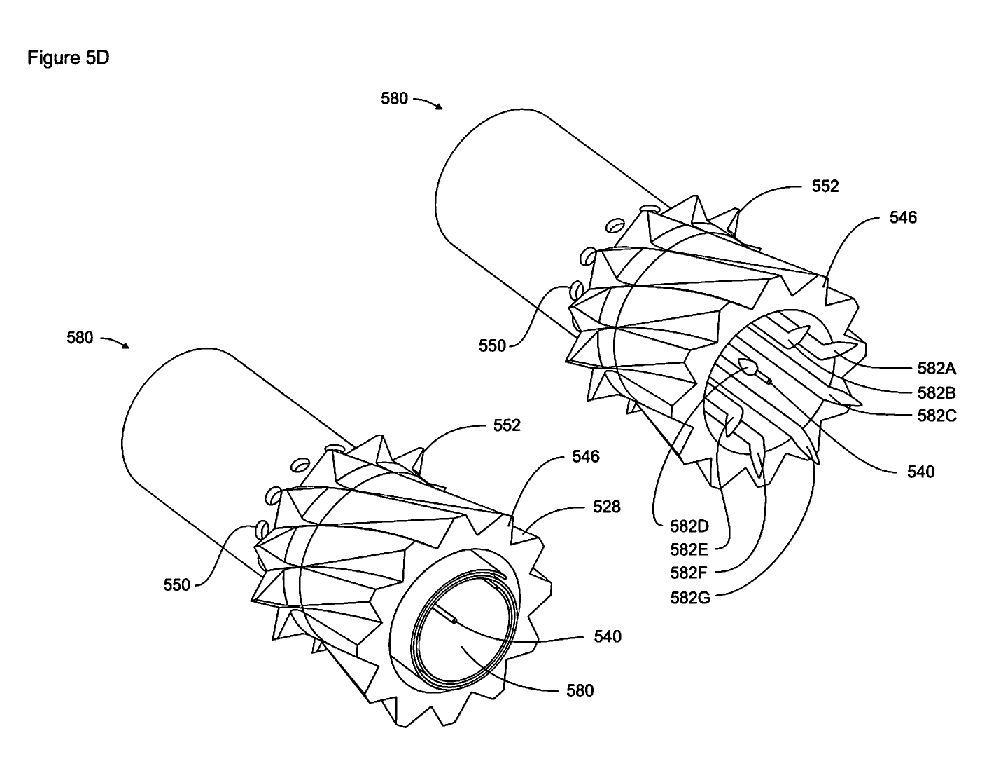

Unreacted oxygen donor and feedstock fuel passes into passageway 616 of collector manifold 618 for delivery to injectors 128A, 128B, 128C, and 128D for operation of combustion engine 102. In certain applications these injectors provide operational features of the injector 500 shown in FIGS. 5A, 5B, 5C and 5D. Illustratively pressurized hydrogen or hydrogen characterized fuel blends are delivered to port 502 and slower burning pressurized fuel selections such as unreacted feedstocks and/or lower pressure fuel selections including fuel blends and/or hydrogen are delivered to port 504. A selector valve such as shuttle valve 508 operated by actuator 506 provides flow from port 504 and actuator 514 opens valve 560 to allow slower burning fuel to pass through one or more ports 550 and the annular passageway between electrodes 552 and 548 enter combustion chamber 542 in pattern 576 which may include flow through passageways formed between straight or curved splines 546.

FIG. 5D shows an embodiment with helical passageways between helical spline electrodes 546 for imparting angular momentum to activated oxidant ions, fuel and/or fuel ions that are launched from injector 500. Depending upon the combustion chamber geometry and piston speed range other embodiments may include vents, turning fins or other features in electrode 548 and/or 552-546 to impart or generate an included angle 576 and/or minor angle 575 to provide suitable air utilization as an oxidant, thermal and/or electrical insulator, and to serve as an expansive gas to produce work. In certain embodiments that provide ion currents such as Lorentz thrust oxidant and/or subsequently introduced fuel ions that are launched from electrodes with provisions for imparting an included angle and minor angle of particle vectors, further adaptive adjustments may be provided by permanent or electromagnets 570A, 570B, and/or 570C.

In some embodiments such electromagnets may include insulated conductors such as anodized or chemically oxidized titanium or tantalum wires that are formed as windings that are capable of operation at temperatures up to about 650° C. Higher temperature operation up to about 950° C. can be provided by carbon wire windings that are made of high conductivity carbon nanotubes and/or nanofibers that are insulated by a sheath of insulative carbon and/or boron nitride.

After establishing minor angle 575 and/or included angle 576 by electrode geometries and/or fuel pressure and/or Lorentz thrust adjustments, acceleration of initiation and/or completion of combustion may be provided by one or more corona discharges in one or more field produced by suitably shaped antenna. In some embodiments formed or sharp features such as thin sheet forms such as one or more tubes or scrolls 580 or needles 582 made of heat resisting materials such as a woven screen of silicon carbide fibers, oxidized tantalum or molybdenum disilicide coated tungsten are utilized to project the electric field for corona discharges. Such embodiments may have protective covers or overlays of alumina, zirconia, molybdenum etc., to resist oxidation or overheating. In certain embodiments such electrodes are cyclically cooled by fuel and/or oxidant that are allowed to flow past valve 560 around permanent or electromagnets 570A, 570B, and/or 570C to also cool electrodes such as 580 or 582A-G.

FIG. 5B shows an end view of a suitable actuator 509 such as an electromagnet or piezoelectric assembly for push-pull on plunger 503 to rotate lever 501 about fulcrum bearing 505 to provide suitably amplified motion of plunger 507 to position valve 508 for selection of flow from port 502 and/or 504. Fluid flow through passageways 510 and 512 around or through actuator 514 is delivered to adaptively positioned valve 560 for flow passage through ports 550 to the annulus between electrodes 548 and 552 and/or around magnets 570A, 570B and/or 570C along with other components such as corona antenna to provide one or more injection pathways into combustion chamber 542. Adaptive positioning of valve 560 to produce such flows is provided by controller 516 in response to data transmitted by filaments such as 540 (FIGS. 5C, 5D) which may include fiber optic and electrically conductive types.

Instrumentation such as sensors that may be included within or communicated to controller 516 through fiber optic bundle 540 provides monitoring of fuel delivery and combustion patterns for adaptive process control of injection pressure, injection timing, and ignition timing. Controller 516 provides adaptive timing and adjustment of the current produced in oxidant and/or one or more subsequent fuel deliveries into annular passageway between electrodes 552 and 548 which along with permanent and/or electromagnets 570A, 570B, and/or 570C provide adjustment of the on currents and thus the velocity and injection pattern 576 that penetrates into combustion chamber 542.

Insulator and/or capacitor 556 may be charged by the circuit that includes transformer inductors 518A-N and insulated conductor 520 to provide for generation of ion currents that vary from less than an ampere to many hundred peak amperes to produce the on population and Lorentz thrust that adaptively produces the desired penetration rate and combustion event that expands from pattern 576. Such ion patterns include activated oxidant ions and radicals such as ozone, oxides of nitrogen and hydroxyls formed from oxidant such as air and/or residual combustion gases from combustion chamber 542 and/or ions and radicals from subsequently injected fuel upon opening of valve 560. Activated oxidant ions are thrust into combustion chamber 542 followed by higher speed launches of pressurized fuel and/or fuel ions and radicals as provided by controller 516 to produce adaptively adjusted combustion events including the pattern and/or rate of initiation and/or completion of combustion.

In operation according to selections or permutations of modes 1-9 pressurized hydrogen collected from annular passageway 626 may be directly injected to accelerate he ignition and completion of combustion of other stratified or homogeneously mixed fuel and oxidant constituents and/or it may be mixed into tank 108 and/or mixed with fuels collected in conduit 618 or accumulator 124.

Adjustments of the hydrogen to feedstock fuel ratio for unthrottled engine operation and/or the rate of combustion can be provided in mixer 120. Mixer 120 also provides hear transfer from higher temperature hydrogen-fuel mixtures from converter 105 to cooler selections of feedstock such as gas from pump-valve 114 delivered by line 115 and/or to vaporize liquid substances from pump-valve 118 delivered by line 119.

Unthrottled operation of the engine with homogeneous charge combustion of the hydrogen-fuel blend is highly advantageous compared to throttled operation and may be utilized to produce rapid engine warm-up and thus to increase the amount of heat (H-1 and/or H-2) that is available for endothermic processes summarized by Equations 1-4 and thus the rate of carbon production. Such homogeneous charge hydrogen-fuel mixture with oxidant such as air may be provided by one or more fuel deliveries through the intake valve(s) during the intake stroke and/or by direct injections before, at, or after bottom dead center (BDC) of the reciprocating piston motion in each cylinder of engine 102.

In instances that the hydrogen-fuel blend is directly injected into the combustion chamber a leaner overall fuel-aft mixture can be readily combusted as a stratified charge according to selection of one or more of the operating modes including various permutations of the previously disclosed modes. Such stratified charge hydrogen-fuel mixture with oxidant such as air may be provided by one or more injections including initiation of injections before, at, or after top dead center (TDC) of a reciprocating piston motion. This provides greater operating flexibility to meet power demand with higher air utilization benefits including faster completion of combustion that is insulated within surplus air and conversion of a greater amount of heat to work by expansion of combustion gases including surrounding insulating air. The result is higher thermal efficiency and improved engine performance along with longer engine life and greatly reduced emissions of objectionable emissions.

According to horsepower hours of operation on specified fuel selections and/or occasionally in response to harvested carbon “fullness” sensors or suitable instrumentation such as may be indicated by measurements of electrical conductivity; capacitance; radiation transmission, absorption and/or reflection, and/or pressure drop through carbon collector media, cartridges 106A-G are isolated by closure of the inlet and outlet valves and replaced by new or recycled cartridges, Recycled cartridges may be prepared with substrates and catalysts appropriate for the types of carbon allotropes that are desired. In the alternative the recycled cartridge may be activated with a particular catalyst selection after it is placed in the carbon deposition circuit shown.

Illustratively the catalyst may be deposited on metallic, ceramic, or selected carbon allotrope surfaces of the collector media from a carbon and hydrogen donor or a metal organic substance such as a copper acetylide or a carbonyl of copper, iron, nickel, cobalt or another metal selection. Subsequent carbon deposition may be by fluid dissociation and/or heat treatment by utilization of H-1, H-2, H-3 and/or other forms of energy such as laser or microwave energy.

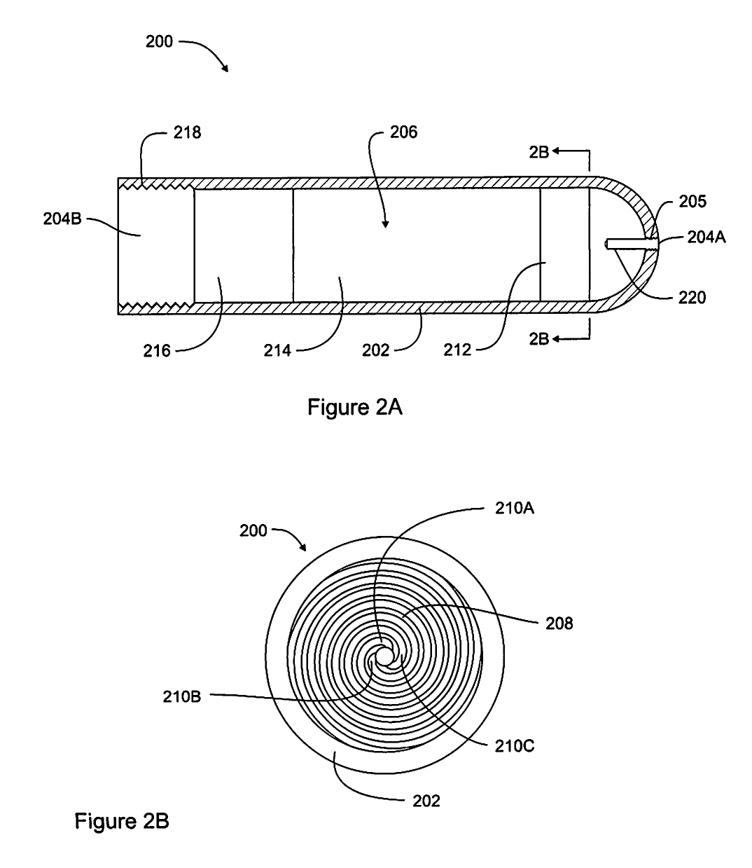

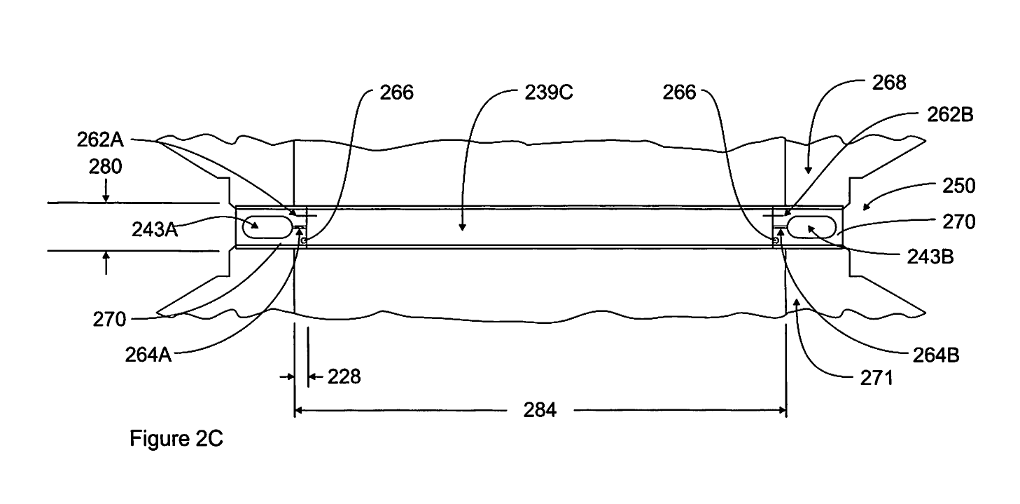

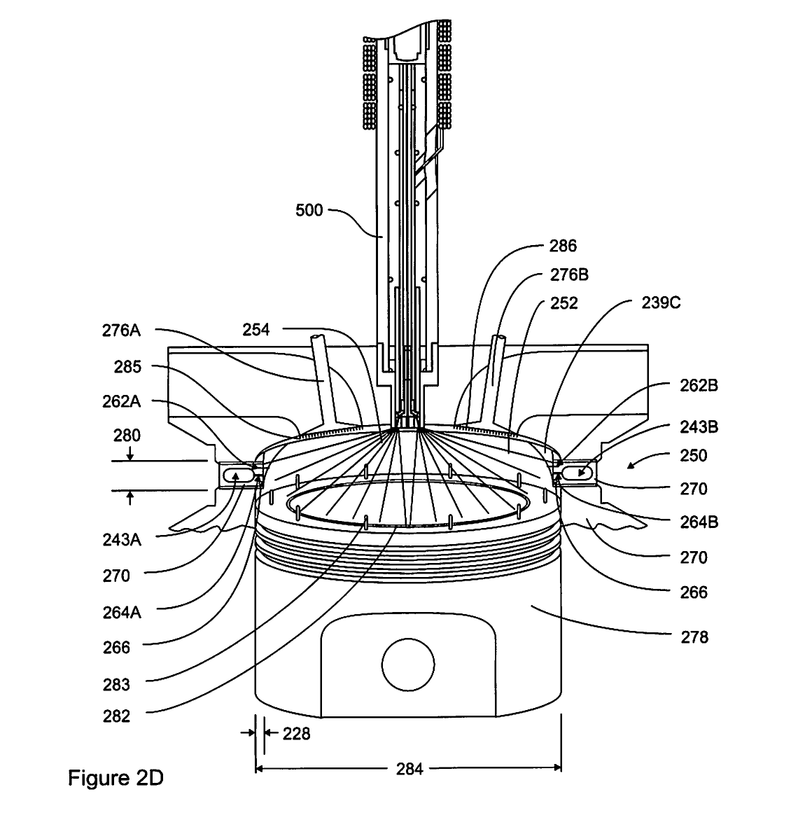

An engine such as a two- or four-cycle piston engine with direct injection of fuel may have various combinations of Lorentz and/or Corona ignition. Fuel may be injected with or without Lorentz on current thrust and ignition may be produced by positive or negative corona that is induced by an injector that includes corona production antenna, which may be negative or positive or alternating polarity at a suitable frequency. In some embodiments fuel and/or Lorentz thrust fuel ions are injected into the combustion chamber and ignition is provided by corona plasma that is generated in the penetrating fuel pattern as a result of a high voltage electric field that is applied by antenna in a combustion chamber insert such as the head gasket during a few nanoseconds. In an illustrative operation, application of a negative field from an insulated antenna in the head gasket produces ozone and/or oxides of nitrogen from the air in the combustion chamber and a field that also ionizes injected fuel particles. Such negative antenna in the head gasket may be sharp edges, rods, needles or other field concentrating features as disclosed in co-pending patent head gasket U.S. provisional patent application Ser. No. 61/990,632, filed on May 8, 2014. Positive field production from an antenna may be provided at selected times or frequency by a wire 266 that is embedded within ceramic or other dielectric substance of the gasket assembly 250 as shown in FIGS. 2C and 2D.

Engine 102 may utilize a head gasket assembly 250 between the head 268 and block 271 to increase, decrease or maintain the effective compression ratio of the engine depending upon the selection of dimensions 280 for the thickness of the assembly, and inset dimension 228 compared to the original cylinder bore dimension 284. Head gasket assembly may also receive gases from the combustion chamber 239C by transfer through slit valve 264A into conduit or accumulator 243A and/or inject fluid such as fuel through slit valve 264B from conduit 243B.

In some embodiments an engine such as a two- or four-cycle piston engine is converted to unthrottled air entry operation with direct injection of fuel. Fuel may be injected with or without Lorentz ion current thrust and ignition may be produced by positive or negative corona that is induced by an injector that includes corona production antenna such as 582A-G. In some embodiments fuel and/or Lorentz thrust fuel ions are injected into the combustion chamber and ignition is provided by corona plasma that is generated in the penetrating fuel pattern as a result of a high voltage electric field that is applied by one or more suitably spaced antenna 262A or 262B in the head gasket 250 during a few nanoseconds. In an illustrative operation, application of a negative field from insulated antenna i.e. 262A-262B in the head gasket produces ozone and/or oxides of nitrogen from the air in the combustion chamber and the field that also ionizes fuel particles in the injected fuel penetration pattern such as hydrogen and/or other fuels such as methane, propane or nitrogenous substances to accelerate ignition and/or completion of combustion. Negative antenna such as 262A and/or 262B may be sharp edges, rods, needles or other field concentrating features as disclosed in co-pending patent applications Ser. No. 13/844,240, filed on Mar. 15, 2013; Ser. No. 14/273,482, filed on May 8, 2014; Ser. No. 13/844,488, filed on Mar. 15, 2013; and Ser. No. 14/273,479, filed on May 8, 2014. Positive corona antenna such as wire or rounded plate 266 may be recessed or mounted within dielectric material such as boron nitride, aluminum oxide or mica 270.

Various combinations of oxidation activation by Lorentz ion thrusting, fuel injection, fuel ion current thrusting in penetration patterns such as 254 along with positive or negative corona production by injector 500 and are utilized to meet a wide range of operating conditions. Such operations may be utilized in additional combinations with positive or negative corona production by antenna 262A-262B in head gasket 250 and/or in one or more other combustion chamber inserts in locations such as piston 278 for positive 282 or negative 283 corona production and/or valves 276A or 276B for negative 285 or positive 286 corona production. Illustratively electrodes 552-546 may produce combustion chamber penetration patterns of positive or negative ions, electrodes 582 may induce positive or negative corona production in such patterns, and insert electrodes such as 262A-F and 266 may induce positive or negative corona production in such patterns,

In various applications the combustion chamber is operated with production of net negative, net positive, or net neutral charges from Lorentz and corona ion generation. As an example the Lorentz launched ions may be negative and the corona induced ions may be equal in charge magnitude to produce an overall net neutral charge count during a cycle of operation. As another example Lorentz launched ions from injector 500 may be negative and the corona induced ions from one or more combustion chamber inserts may be negative to produce an overall net negative charge count. In another example the Lorentz launched ions may be positive and the corona induced ions may be negative for an overall count of net negative or positive. As another example oxidant may be negatively or positively ionized by Lorentz and/or corona to produce ozone and other activated oxidant particles followed by negative or positive Lorentz launched fuel ions for an overall count of negative or positive charge count.

In some instances radiant, thermal or pressure energy produced in combustion chamber 252 is converted into electrical energy for such operations. Adaptive combinational selections, timing, duration, and magnitude of such operational events is provided by controller 516 and may be utilized in combination with other controllers that are co-located with gasket assembly 250 to optimize fuel efficiency, power production and engine life along with production of suitable exhaust temperature and pressure for operation of carbon collection in system 105.

Removal of selected allotropes may include surfactant aided solvents, super-acid and/or ultrasonic suspension in suitable fluid vehicles or solvents. In another embodiment substrates and collected allotropes may be harvested by mechanical means including crushing or pulverizing of the carbon loaded substrate materials.

In another embodiment, the filter media cartridge comprises one or more selections of allotropes and is utilized in a filter assembly for fluids such as pharmaceutical preparations, milk, beer, whiskey, water, air or natural gas including removal of objectionable substances such as hydrogen sulfide or halogenated substances. System 200 of FIG. 2A shows a side view including utilization of one or more types of carbon collection cartridges 212, 214, 216, etc., in canister 202 for such applications.

In many applications greater filtration and/or catalytic efficiency can be improved by providing relatively even flow rates of feed fluid or reactant that is processed. Feed fluid entering the filter bed 212 through conduit 204A and distribution passageways from conduit 220 is fed through equal impedance spiral passageways such as 210A, 210B, and 210C between walls such as 208 after entering the passageways through fitting 205. This evenly distributes feed fluid for separation of filtrate or interaction with catalytic substances prepared from collected carbon and/or that utilize collected carbon to present and/or provide heat transfers to or from reactants during axial fluid flow through the collection and/or filter media 206 towards even-flow delivery to a similar fitting at location 204B within zone 218 which may provide for retention and/or sealing of assembled components by threaded section 218 in which spiral passageways collect the product fluid.

In another embodiment, for example as shown in FIGS. 3E-F, the collected carbon allotrope or cartridge assembly with collected carbon is utilized as a thermal capacitor or flywheel in applications such as solar collectors to store thermal energy during the day and to heat working fluids such as air or water at other times such as at night. System 300 includes transparent glazing 301 and light transmissive or reflective walls 303 and one or more glazings i.e. 305A and 305B to form one or more passageways such as 304, 306 and 308. In operation a fluid such as carbon dioxide is contained within or flows through channel 304, the same or another fluid such as air is contained within or flows through channel 306 and the same or another fluid such as water is contained or flows through channel 308.

In the day solar energy frequencies such as IR, Visible and UV pass through to heat fluid in channel 308 and thermal capacitor 302A and/or 302B and such heat is trapped by fluids such as water, air, or carbon dioxide in channels 308, 306 and/or 304. Collection of solar energy by such trapping functions including absorption and/or insulation by the fluids contained in channels 304, 306, 308 and/or carbon heat capacitor 302A and/or 302B is warmed to an elevated temperature that is controlled by the flow of such fluids to heat exchangers such as space and water heaters. At night the fluids in channels 304 and 306 are contained and the fluid such as water in channel 308 is circulated to deliver heat including conductive and radiative transfers from carbon thermal capacitor 302. Another embodiment 300B is shown in FIG. 3F with suitable cross sectional shapes such as carbon thermal capacitors 302B and one or more carbon thermal capacitors of suitable cross sections 302C, 302D, 302E in selected channels.

The systems of FIGS. 3A, 3B, 3C and 3D show collected carbon cartridges such as 315A, 315D, 320B, 320C, and 350D that are produced in the cross sectional shapes and sizes needed for such applications. FIGS. 3A-G depict the cross sections of carbon collection embodiments and how shapes such as 302C, 315A, 320C, and 394 or bordering selected features or portions of 320A, 320D, 330A, 330B, 330D, 340C, 340D, 351D, 360D, and/or 350A, are produced by carbon collection cartridges to provide economical components for such applications. In some embodiments such carbon is deposited on various allotropic carbon aerogels including various proportions of nanotube and graphene mixtures or composites, graphite or amorphous carbon foams or fibers including materials and/or composites with suitable properties and forms including metals such as steel or stainless steel wool, nickel, copper, etc. and/or lava foam, rock wool, fiber glass, and/or ceramic honeycombs, fibers, foams or other suitable structures.

In certain applications assemblies such as shown in FIGS. 3A-G are further insulated from the support surface by a selected aerogel such as a silica, zirconia, or carbon such as graphene and/or nanotube or fiber aerogel, rock wool, or other forms of carbon, or silica, or basalt foam, fiber, or reflective materials 350D such as fiber glass, rock wool and/or oriented graphite or graphene foil to protect the support surface such as the roof or wall of a building. Convenient packaging of such assemblies may be provided by an appropriate adhesive tape, thin film or shrink tube that covers some regions or all of components such as glazing 370D, internal components and thermal capacitor 315D as illustrated by 351D.

Low density materials such as carbon aerogels can initially have a lower density than helium and can be used as carbon collection host shapes such as 106, 315A, 320C, 394 etc., for carbon removal from carbon donor fluids. Aerogels can provide virtually any other desired cross section shape or three-dimensional form to controllably produce denser composites that have functions such as activated carbon filters, thermal and/or electrical capacitors, and serve as coatings or components with blacker-than-black absorptivity for a wide range of radiation frequencies etc. Illustratively open cell aerogels may have 1-10% solid structure such as may be provided by silica, zirconia, or carbon such as nanotubes and/or graphene in suitable shapes that are loaded with collected carbon to the product density and selected specifications including section modulus, specific heat, optical absorptivity values.

Translucent photovoltaic circuits for converting solar energy into electricity may be applied to selected areas such as the first or second surfaces of glazings 300A, 300B, 310A, 310B, 310C, 310D, and/or 370D. Solar energy not converted into electricity may be transmitted to lower passageways or components such as thermal capacitors and/or removed by adaptive circulation to improve the performance of the photovoltaic circuits of suitable fluids such as air, carbon dioxide, water, antifreeze solutions, etc., in passageways 304, 306, and/or 308 including transfer of such heat to thermal capacitors such as 302A, 302B, 302C, 315A, 320B, 320C, and/or 315D. This provides lower operating temperature of photovoltaic components and circuits as heat is delivered to separated zones and considerably greater energy collection and utilization along with building protection than conventional photovoltaic or thermal collection systems.

Collected carbon may be utilized as feed stock for many subsequent applications including reinforcement, stabilizer, UV blocker, or colorant for polymeric compounds including thermoplastics, thermosets and elastomers in applications such as tires, O-rings, and flexible tubing. Other subsequent applications include a wide range of sizes of electricity conduction rods for welding, cutting, and melting metals such as cast iron and steel. Another subsequent application of collected carbon is to serve as a source for various forms of carbon coatings and/or carbon enhanced layers such as case hardened steel and other alloys. In other instances carbon electrodes are used in metal plating systems including production of metals such as aluminum by fused salt electrolyzers.

In many durable goods applications a diamond like carbon coating (DLC) is applied to improve the durability, strength and optical properties. Coated objects range in size from nano-optics to architectural components. Illustratively, the outer layers of roofing, siding and other architectural embodiments are coated with various grades of DLC. In an application circular point focus or linear line focus Fresnel lens are DLC coated to protect the accuracy, durability, and cleanability in hostile environments. DLC coatings on photovoltaic, concentrating and/or Fresnel lens glazings 360A, 310C, and 370D provide protection and improved performance.

Various other embodiments are shown in FIGS. 3A, 3B, 3C, 3D, 3E, 3F and 3G. In an exemplary application polymer and/or glass tubes 340A, 340B, 330C, and 380D of suitable cross sections and shapes are utilized to convey a suitable fluid such as air or water or water and photovoltaic particles or another fluid such as ethylene glycol with carbon particles suspended as colorant and/or carbon thermal flywheel matter. Some embodiments of such tubes provide suitable compositions of thin walled glass liners within sheaths of protective polymer and/or carbon (i.e. DLC) or other strong coatings. Similarly, one or more glass and/or polymer glazings 360A, 310C, and 370D support transparent or translucent photovoltaic layers in certain applications.

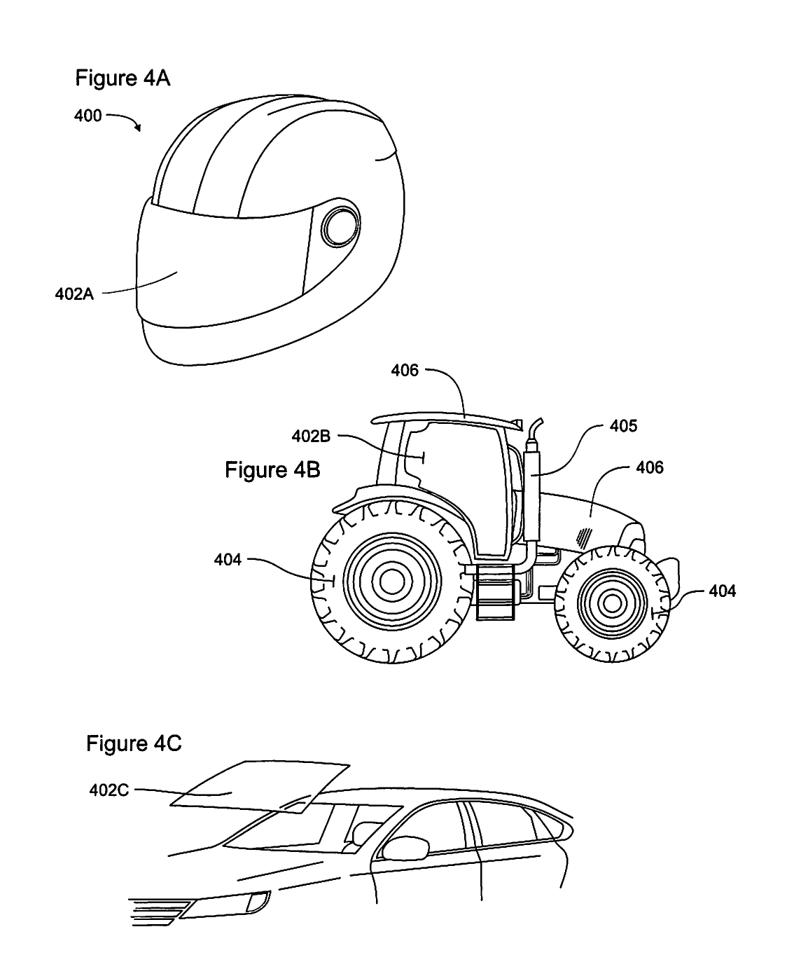

Similarly as shown in FIGS. 4A, 4B, and 4C sporting goods including protective helmets 400 and various transparent eye protection components and embodiments such as 402A, 402B, 402C, are DLC coated to improve performance and durability, Farm implements such as tillage equipment, grain augers, hay slides, conveyer components, crop dryers, and milking machine components are DLC coated to provide better performance and longer life. Vehicle windshields and other windows including aircraft windshields and anti-icing and washing equipment are DLC coated to protect against scratching, chemical attack, and notch weakening of brittle materials. Various other forms of carbon such as carbon black for preventing UV radiation and oxidation damage to polymers including tires 404 and paint coatings 406 are produced by carbon collection system 105. Carbon fibers 110 that reinforce tanks 108 and 124 along with pressure rated conduits 115 and 119 and/or tires 404 are produced from carbon collected by system 105, 405, and H-1, H-2, and/or H-3 energy converters on a suitable portion of more than a billion other engines including piston and turbine designs.

In many applications the collection of carbon from hydrogen and carbon donor feed stocks provides activated carbon for improving the utilization efficiency of irrigation along with fertilizer and plant nutrient substances. In such instances as shown in FIG. 7 the collected carbon is crushed into particles 702 about the size of salt crystals (or larger or smaller) that are loaded with fertilizer and/or nutrients and planted at the appropriate time to nourish a crop. In other applications the collected carbon may be utilized in a layer 706 around a surface or subterranean drip irrigation conduit 704 or in selected strategic locations such as adjacent configurations such as tubes or strips 708A near to a drip irrigation conduit 704. This provides for loading or charging the collected carbon with water and/or fertilizer and/or plant nutrients to enable roots to grow to and around such extended sources 708B of water and nutrients. Cyclic delivery through 704 to replenish embodiments 702, 708A and/or 708B with water and/or nutrients provides extended duration of availability to encourage root growth toward 708A and/or 708B and away from tubes 704. In certain embodiments delivery tubing 704 and/or 708A or 708B includes substances that reduce or eliminate root invasion that would clog or impede water or nutrient delivery to plants. System 702 reduces or eliminates wasteful and problematic run-off of water and fertilizers.

In another application, system 100 is utilized as a stationary combined heat and power plant that also produces net-hydrogen fuels for mobile applications. In operation hydrogen is produced by processes such as summarized by Equations 1-10 on various occasions at a rate in excess of the requirement for unthrottled oxidant intake and homogeneous or stratified charge operation of engine 102. The excess hydrogen is combined with nitrogen and/or carbon dioxide from the atmosphere and/or nitrogen and/or an oxide of carbon from more concentrated sources to produce net-hydrogen fuels such as alcohols (i.e. methanol, ethanol, propanol, butanol, etc.) fuel acids (i.e. acetic, formic, etc.) ethers (i.e. dimethyl ether or DME, diethylether or DEE, etc.). Equations 11, 12, 13, 14 and/or 15 illustratively generalize such production of a net-hydrogen liquid fuel from an oxide of carbon (i.e. carbon dioxide or carbon monoxide) and/or nitrogen from the atmosphere or more concentrated sources such as a smoke or exhaust stack of a power plant, petroleum refinery, brewery, bakery, Portland cement calciner, ethanol plant, incinerator, or organic waste digester. Equation 15 further depicts utilization of intermediates such as farm or forest wastes, fuel alcohols, and nitrogenous compounds in various combinations of carbon, hydrogen, nitrogen and/or oxygen in chemical compounds, solutions or suspensions including polymers and hydrides for storing and/or transporting hydrogen.

CO₂+2H₂→CH₃OH+H₂O Equation 11

N₂+CO+2H₂→CH₄N₂O Equation 12

CO₂+H₂→HCOOH Equation 13

CH₃OH+H₂O+CH₄N₂O→Net-H₂ Liquid Fuel Solution Equation 14

CH₃OH+NH₃→NH₃CH₃OH (Hydrogen Delivery Fuel) Equation 15

In some embodiments such net hydrogen liquid fuels are stored in an accumulator such as tank 108 to serve as a hybridized energy accumulator for chemical and pressure energy values. In many applications this enables an efficient CHP system to more than double the energy utilization efficiency compared to baseline fossil or nuclear fueled central power plants including distributed production and synergistic storage of net hydrogen fuel liquids for enabling mobile applications using repurposed gasoline or diesel fuel pipelines and tanks.

Small but scalable to large production of liquids such as shown in exemplary Equations 8-11 can readily utilize hydrogen and reactant selections such as carbon monoxide, carbon dioxide and nitrogen in pressurized reactions that efficiently provide for transport and storage of hydrogen as a constituent of liquids as shown. Such liquid fuels provide environmentally beneficial net-hydrogen combustion cleanliness and highly favorable economy of ambient temperature liquid storage and transportation.

The present method of separating hydrogen and carbon from substances that ordinarily combust or rot into the atmosphere and utilizing the hydrogen to produce liquid fuels and the carbon to produce durable goods greatly improves the efficiency and reduces the environmental impact of technologies disclosed in U.S. patent disclosure references such as U.S. Pat. Nos. 5,767,165; 4,396, 539; 4,609,441; 4,613,623; 4,623,639; 4,992,480; 4,935,395; 4,861,360; and U.S. Pat. No. 4,623,634 which are known to be low-cost producers of liquid fuels for storage and delivery of hydrogen.

Utilization of inexpensive hydrogen produced by the present embodiments with low-cost processes such as disclosed in these and other patent references provides distributed production of inexpensive liquid fuels that perform as net-hydrogen dean fuels and enable conversion of existing engines that can actually dean the air, last longer, and produce more power when needed. The rapidly growing global population of more than a billion engines in transportation applications provides a sufficient number of engines from wrecked vehicles that can be repurposed for operation in stationary engine-generator sets that overcome dependence upon central power plants. In various applications including combined heat and power operations, such unthrottled engines can utilize hydrogen or net-hydrogen fuel preparations to overcome objectionable greenhouse gas contributions including carbon particles, oxides of carbon, hydrocarbons and oxides of nitrogen.

In summary the present embodiments provide economic benefits by extracting carbon from substances that ordinarily rot or burn to produce durable goods along with co-production of hydrogen to enable heat engines to operate with unthrottled air intake to improve performance and thermal efficiency along with longer life and lower maintenance costs. Accordingly, the present invention enables much larger returns on the enormous investments that have been made to produce the global population of more than a billion vehicles and most of the fossil fuel production and distribution infrastructure. It also enables much more efficient distributed energy systems to overcome unacceptable emissions of heavy metals, particulates, oxides of nitrogen, and carbon dioxide by providing combinations of heat and electric power including electricity delivery through existing electric grid infrastructure.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A system for chemically combusting a feedstock that requires a first ratio of feedstock to oxidant for ignition and self-propagated combustion,
wherein the first ratio requires attenuation of the oxidant availability as the feedstock is attenuated to provide ignition and self-propagated combustion,
wherein the system separates the feedstock into at least a first chemical constituent and a second chemical constituent, and
wherein the first or second constituent is selected to provide a ratio of selected constituent to oxidant proportions that sufficiently exceeds the first ratio of feedstock to oxidant proportions to provide for ignition and self-propagated combustion of the selected constituent without requiring attenuation of the oxidant.

2. The system of claim 1 in which the feedstock contains hydrogen.

3. The system of claim 2 in which the selected constituent is hydrogen.

4. The system of claim 1 in which the ignition is by at least one of heat, pressure, electrically induced ionization, catalytic oxidation, and radiation induced oxidation.

5. The system of claim 1 in which said ignition and self-propagated combustion is by stratified charge presentation of at least one of the feedstock, the selected constituent, and the constituent not selected.

6. The system of claim 1 in which said ignition and self-propagated combustion is by homogeneous charge presentation of at least one of the feedstock, the selected constituent, and the constituent not selected.

7. A method for chemically combusting a feedstock, the method comprising:
providing a feedstock;
separating the feedstock into a first constituent and a second constituent;
adding an oxidant to the feedstock in a first ratio sufficient to enable ignition and self-propagated combustion;
optionally attenuating an availability of the oxidant upon attenuation of the feedstock to enable ignition and/or self-propagated combustion; and
wherein the first or second constituent is selected to provide a ratio of selected constituent to oxidant proportions that sufficiently exceeds the first ratio of feedstock to oxidant proportions to provide for ignition and self-propagated combustion of the selected constituent without requiring attenuation of the oxidant.
